(19) United States
(12) Patent Application Publication
(10) Pub. No.: US 2025/0356410 A1
(43) Pub. Date: Nov. 20, 2025

(54) NON-TRANSITORY COMPUTER READABLE STORAGE MEDIUM, SERVER, AND LABEL DATA SHARING SYSTEM

(71) Applicant: BROTHER KOGYO KABUSHIKI KAISHA, Nagoya (JP)

(72) Inventor: Fuyuko Ito, Nagoya (JP)

(21) Appl. No.: 19/281,482

(22) Filed: Jul. 25, 2025

Related U.S. Application Data
(63) Continuation of application No. PCT/JP2024/002786, filed on Jan. 30, 2024.

(30) Foreign Application Priority Data
Feb. 3, 2023 (JP) 2023-015627

(51) Int. Cl. G06Q 30/0601

(52) U.S. Cl. CPC G06Q 30/0633; G06Q 30/0641

(57) ABSTRACT

A non-transitory computer readable storage medium stores a program configured to be executed by a server. The server is configured to store label data. The label data is configured to be printed by a label printer. The label data is configured to include a setting of a paid content or paid function. The server being configured to access a purchase information database. The purchase information database storing purchase information indicating whether a paid content and function have been purchased for each user ID.

### REFERENCE TO RELATED APPLICATIONS

This is a continuation application of International Application No. PCT/JP2024/002786 filed on Jan. 30, 2024, which claims priority from Japanese Patent Application No. 2023-015627 filed on Feb. 3, 2023. The entire contents of the aforementioned applications are incorporated herein by reference.

### BACKGROUND ART

In the related art, as a system for using content data, a system is known in which a server for storing content data is prepared on the Internet, content data is posted from a device of a user, that is, uploaded to the server, and the content data is downloaded to a device of another user. In such a system, in order to promote posting of content data, a user who has posted content data may be granted points available in the system.

In a points management system disclosed in a related art, when photograph data is uploaded from a PC of a user A to a WWW server, and the photograph data is purchased and downloaded from the WWW server by a PC of a user B, points corresponding to the purchase amount are added to the user B as the purchaser, and points corresponding to the data size of the photograph data are added to the user A as the poster when the photograph data is uploaded or when the photograph data is downloaded.

In recent years, a system for using label data used for printing a label in a label printer has been studied. The label data can be implemented with combining various contents, and the types of the contents include paid contents. Further, the label data can include settings related to the paid function.

In order to use label data including settings of paid content or paid function on a device on the download side, it is necessary to purchase the paid content or paid function. However, it is difficult for a user on the download side, that is, a user who uses the label data to determine which content or function needs to be purchased. It is also troublesome to search for and purchase paid contents and paid functions included in the label data. The related art does not include description regarding paid content and functions and thus has room for improvement.

### SUMMARY

A non-transitory computer readable storage medium storing a program configured to be executed by a server,
the server being configured to store label data,
the label data being configured to be printed by a label printer,
the label data being configured to include a setting of a paid content or paid function,
the server being configured to access a purchase information database,
the purchase information database storing purchase information indicating whether a paid content and function have been purchased for each user ID,
the program including instructions which, when executed by the server, cause a computer of the server to execute:
   download acceptance processing of accepting a user ID, selection of the label data to be downloaded, and a download instruction, from an information processing device,
   in a case where the download instruction from the information processing device is accepted in the download acceptance processing:
      transmission processing of transmitting the label data selected in the download acceptance processing to the information processing device;
      acquisition processing of accessing the purchase information database to acquire the purchase information corresponding to the user ID accepted in the download acceptance processing; and
      determination processing of determining whether the label data selected in the download acceptance processing includes a setting of an unpurchased content or function, based on the purchase information acquired in the acquisition processing, and
   in a case where it is determined in the determination that the setting of unpurchased content or function is included:
      proposal processing of proposing purchase of the unpurchased content or function included in the label data selected in the download acceptance processing.

### BRIEF DESCRIPTION OF DRAWINGS

FIG. 1 is a diagram schematically illustrating a label data sharing system according to the present embodiment.

FIG. 2A is a schematic diagram illustrating an electrical configuration of a front server. FIG. 2B is a schematic diagram illustrating an electrical configuration of a management server.

FIG. 3A is a diagram illustrating an example of user related information stored in a user database. FIG. 3B is a diagram illustrating an example of posted label related information stored in a posted label database.

FIG. 4 is a sequence diagram illustrating an example of a procedure of label post in label data sharing service processing provided to a user by a front server program of the front server, including operations of a client application of a terminal and a management server program of the management server.

FIG. 5 is a diagram schematically illustrating the terminal when newly posting a label.

FIG. 6A is a sequence diagram illustrating an example of a procedure of download of posted label data in the label data sharing service processing provided to a user by the front server program of the front server, including operations of the client application of the terminal and the management server program of the management server.

FIG. 6B is a sequence diagram illustrating the example of the procedure of download of posted label data in the label data sharing service processing provided to a user by the front server program of the front server, including operations of the client application of the terminal and the management server program of the management server.

FIG. 7A is a diagram schematically illustrating the terminal when selecting a label.

FIG. 7B is a diagram schematically illustrating the terminal when notifying an unpurchased content.

FIG. 7C is a diagram schematically illustrating the terminal when notifying an unused tape.

FIG. 8A is a sequence diagram illustrating an example of a procedure of label download in the label data sharing service processing provided to a user by the front server program of the front server, including operations of the terminal and a management server according to the second embodiment.

FIG. 8B is a sequence diagram illustrating the example of the procedure of label download in the label data sharing service processing provided to a user by the front server program of the front server, including operations of the terminal and a management server according to the second embodiment.

### DESCRIPTION

### First Embodiment

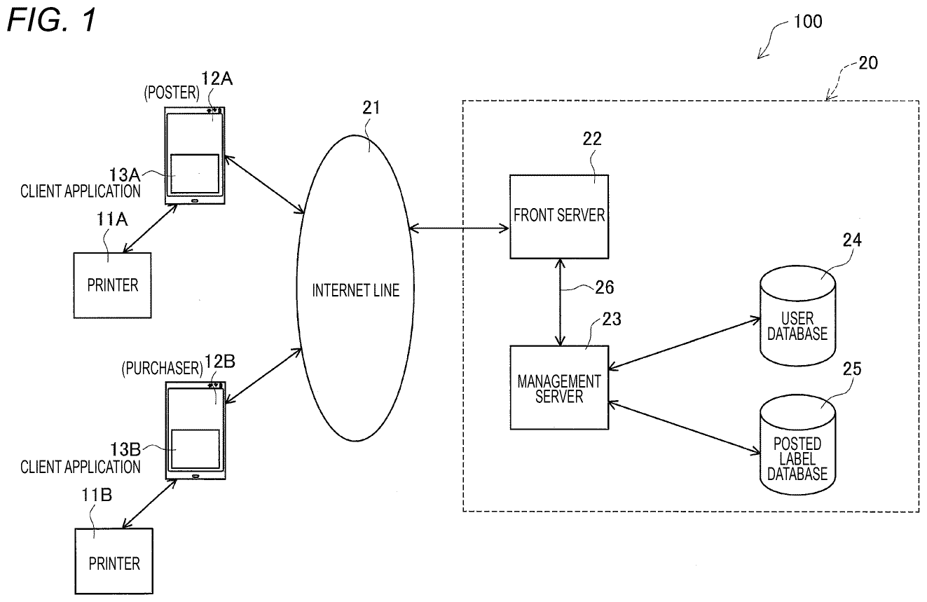

Hereinafter, an embodiment of a label data sharing system according to the present embodiment will be described in detail with reference to the drawings. FIG. 1 is a diagram schematically illustrating the label data sharing system.

That is, as illustrated in FIG. 1, the label data sharing system 100 according to the present embodiment is a system provided to the user by the vendor (manufacturer) of a printer 11. In the label data sharing system 100 according to the present embodiment, the owner or the user of the printer 11A and the printer 11B can post, that is, upload, the label data printed by the printer 11A and the printer 11B to a label data sharing server 20 from a terminal 12A and a terminal 12B. Further, in the label data sharing system 100 according to the present embodiment, the users of the printer 11A and the printer 11B can download the label data from the label data sharing server 20 to the terminal 12A and the terminal 12B, and then create a label by performing printing based on the label data using the printer 11A and the printer 11B connected to the terminal 12A and the terminal 12B.

In the label data sharing system 100 according to the present embodiment, when label data is downloaded, if the label data includes a paid content or function that needs to be purchased, the user is guided to purchase the paid content or function. When a user purchases the paid content or function, points are granted to the user who posted the label data.

The terminal 12A and the terminal 12B are implemented with a smartphone owned by the user, and may be implemented with tablets or personal computers. Further, the terminal 12A and the terminal 12B is configured to store client applications 13A and 13B provided to users by the vendors (manufacturers) of the printer 11A and the printer 11B. The printer 11A and the printer 11B may be collectively referred to as a “printer 11” if it is not particularly necessary to distinguish them. In addition, the terminal 12A and the terminal 12B may be collectively referred to as a “terminal 12” if it is not particularly necessary to distinguish them. The client applications 13A and 13B may be collectively referred to as a “client application 13” if it is not particularly necessary to distinguish them.

The client application 13 has a function of creating and editing label data on the terminal 12. The client application 13 has a function of uploading the created label data to the label data sharing server 20. The client application 13 has a function of downloading label data from the label data sharing server 20. The client application 13 has a function of printing the label data created on the terminal 12 and the downloaded label data using the printer 11.

The printer 11 is connected to the terminal 12 by wireless LAN communication such as Wi-Fi (registered trademark) or short-range wireless communication such as Bluetooth (registered trademark). The printer 11 and the terminal 12 may be connected by wire using a USB communication standard.

Next, to briefly describe the label data sharing server 20 constituting the label data sharing system 100 according to the present embodiment. The label data sharing server 20 includes: a front server 22 connectable from multiple terminals 12 via an Internet line 21; and a management server 23. The front server 22 and the management server 23 may be connected via an Internet line or a LAN line. In the present embodiment, the front server 22 and the management server 23 are configured as separate servers, but the front server 22 and the management server 23 may be configured as a single server. The label data sharing server 20 is an example of a server.

A user database 24 and a posted label database 25 are connected to the management server 23. The user database is an example of a purchase information database. The user database 24 and the posted label database 25 may be integrated into a single database.

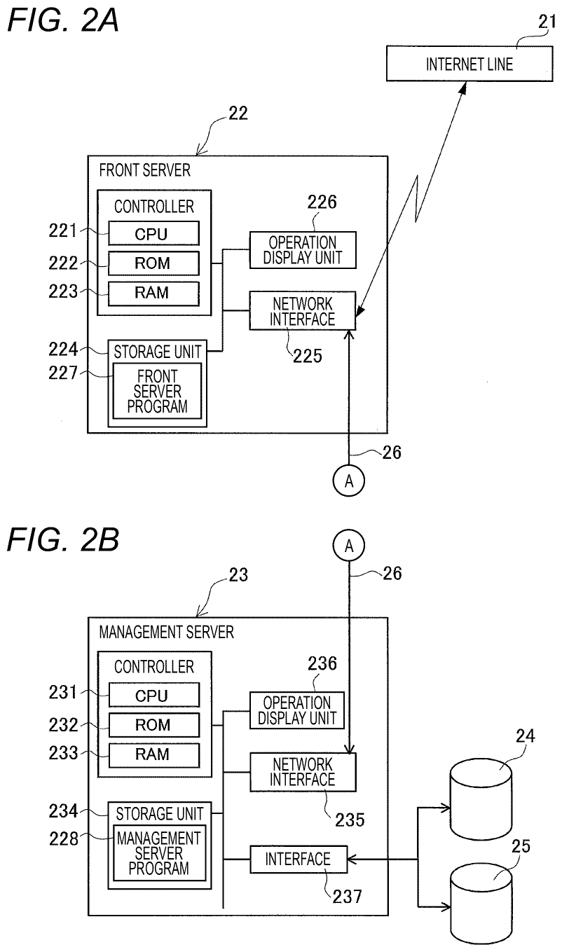

As illustrated in FIG. 2A, the front server 22 includes a CPU 221, a ROM 222, a RAM 223, a storage unit 224, a network interface 225, and an operation display unit 226. The ROM 222 stores an activation program for activating the front server 22 and the like. The RAM 223 is used as a work area when various types of processing are executed, or as a storage area for temporarily storing data.

The storage unit 224 includes, for example, an HDD, or a flash memory, and stores a front server program 227 and various types of processing programs.

The CPU 221 executes various types of processing in accordance with programs read from the ROM 222 or the storage unit 224.

In the present embodiment, the network interface 225 is implemented with an interface of a wired LAN communication standard. In addition, the network interface 225 may be, for example, an interface of a wireless LAN communication standard such as Wi-Fi (registered trademark), an interface of a USB communication standard, or an interface of a short-range wireless communication standard such as Bluetooth (registered trademark). The network interface 225 is connected to the Internet line 21.

The operation display unit 226 includes, for example, a display device and a touch panel disposed on the display device. The display device is configured to display necessary information, and the touch panel accepts an input from a user.

As illustrated in FIG. 2B, the management server 23 includes a CPU 231, a ROM 232, a RAM 233, a storage unit 234, a network interface 235, an operation display unit 236, and an interface 237. The ROM 232 is configured to store an activation program for activating the management server 23 and the like. The RAM 233 is used as a work area when various types of processing are executed, or as a storage area for temporarily storing data.

The storage unit 234 includes, for example, an HDD, or a flash memory, and stores a management server program 238 and various types of processing programs.

The CPU 231 executes various types of processing in accordance with programs read from the ROM 232 or the storage unit 234.

In the present embodiment, the network interface 235 is implemented with an interface of a wired LAN communication standard. In addition, the network interface 235 may be, for example, an interface of a wireless LAN communication standard such as Wi-Fi, an interface of a USB communication standard, or an interface of a short-range wireless communication standard such as Bluetooth. The network interface 235 is connected to the network interface 225 of the front server 22 via the wired LAN line 26.

The operation display unit 236 includes, for example, a display device and a touch panel disposed on the display device. The display device is configured to display necessary information, and the touch panel accepts an input from a user.

The interface 237 is connected to the user database 24 and the posted label database 25. The user database is an example of a purchase information database.

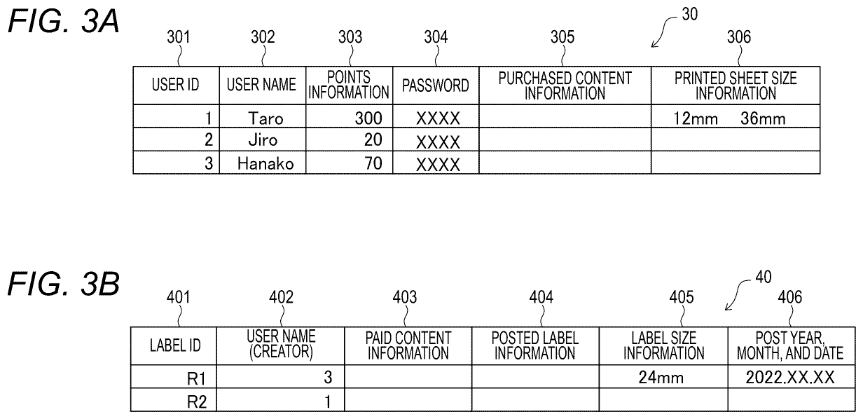

The user database 24 stores user related information 30 illustrated in FIG. 3A as a table. The user related information 30 includes a user ID 301, a user name 302, points information 303, a password 304, purchased content information 305, and printed sheet size information 306 for each user of the terminal 12.

The user ID 301 is identification information for identifying a user who uses the label data sharing system according to the present embodiment, and specifies a user who uses the terminal 12. The user name 302 is a name, a nickname, an address, contact information, an e-mail address, or the like of an individual or an organization (corporation) of a user provided with the label data sharing service according to the present embodiment. When a label is posted for the first time using the label data sharing system according to the present embodiment, a user ID for specifying a user who posts the label is newly set and additionally stored in the user ID 301 of the user database 24. At the time of posting, the user name or the like input by the user on the terminal 12 is additionally stored in the user name 302 corresponding to the new user ID of the user database 24.

The points information 303 is the number of held points in the label data sharing system according to the present embodiment. The held points can be used instead of cash when using the label data sharing system according to the present embodiment to purchase a paid content or function, or a printing sheet (label tape). The password 304 is a password set by each user stored in the user name 302. The purchased content information 305 is information on a paid content or a function purchased by the user using the label data sharing system according to the present embodiment. The printed sheet size information 306 is size information on the printing sheet (label) when the user performs printing using the printer 11 in the label data sharing system according to the present embodiment, that is, the printing sheet width of the label tape as in the present embodiment. The purchased content information is an example of purchase information.

The posted label database 25 stores posted label related information 40 illustrated in FIG. 3B as a table. The posted label related information 40 includes, for each label posted in the label data sharing system according to the present embodiment, a label ID 401, a user ID 402, paid content information 403, posted label data 404, label size information 405, a post year, month, and date 406, and the like.

The label ID 401 is a serial number sequentially assigned to each label posted by the user in the label data sharing system according to the present embodiment. The user ID 402 is a user ID 301 of a user who posts using the label data sharing system according to the present embodiment. The paid content information 403 is information on a paid content or function included in the posted label. The posted label data 404 is label data that is posted, and is data indicating the configuration of a label. The label size information 405 is size information on a printing sheet necessary for printing the posted label data. The post year, month, and date 406 is the year, moth and date when the label data is posted.

### (Post of Label)

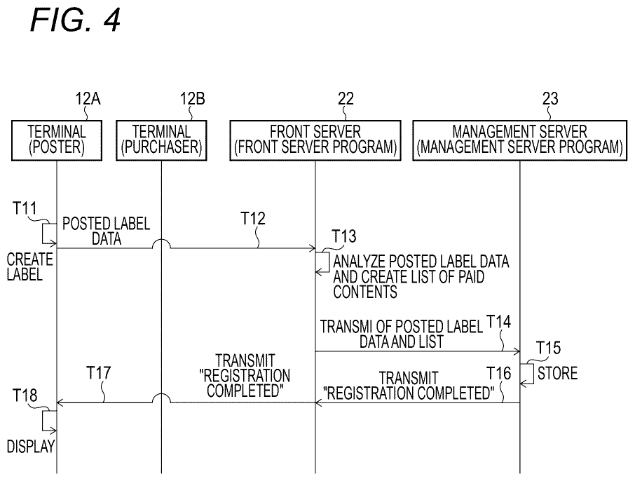

Next, an example of a procedure of label post in the label data sharing service processing provided by the front server program 227 of the front server 22 including operations of the client application 13 of the terminal 12 and the management server program 228 of the management server 23 will be described with reference to the sequence diagram of FIG. 4. The front server program 227 is an example of a program.

Processing steps in the present embodiment basically indicate processing of the CPU 221 according to instructions mainly described in programs such as the front server program 227. The processing by the CPU 221 also include hardware control using APIs of the OS. In the present specification, a detail description of the OS is omitted, and an operation of each program is described.

In the label post according to the present embodiment, first, a user (hereinafter, referred to as a poster) who intends to execute post of label data activates the client application 13A of the terminal (poster) 12A and creates label data to be posted on the terminal (poster) 12A (procedure 11 (hereinafter, referred to as T11)).

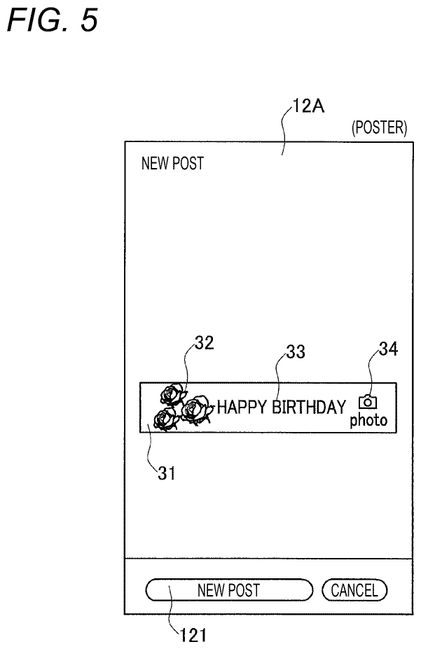

Specifically, as illustrated in FIG. 5, the label data 31 includes a first paid content 32, a second paid content 33, and a third paid content 34. The paid content 32 to 34 is, for example, a special font, a pictogram, a character image, or a decoration image. The paid content may be a paid function. Examples of the paid function include a character color inversion function, a left-right inversion function, a repetitive printing function, and a database printing function. The label data 31 may include free content.

Thereafter, when the poster touches a “new posting” button 121 displayed on the terminal (poster) 12A, the client application 13A of the terminal (poster) 12A transmits, to the front server 22, the user ID of the poster, posted label data which is label data created by the poster, sheet size information suitable for printing the posted label data, and the like (T12). For example, the front server program 227 provides a web page for posting, the web page is displayed by a browser function of the client application 13A, the user ID is input when logging in to the front server 22 via the web page, and then an instruction to transmit the posted label data is input via the web page, so that the posted label data and the sheet size information are uploaded to the front server 22. The posted label data is an example of label data.

Then, upon receiving the posted label data and the like transmitted from the terminal (poster) 12A, the front server 22 analyzes the received posted label data and creates a list of paid contents included in the posted label data (T13). Thereafter, the front server 22 transmits to the management server 23 the user ID of the poster, the posted label data, the sheet size information on the posted label, the list of created paid contents, and the like (T14). The processing of T13 is an example of reception processing.

Then, upon receiving the posted label data and the like, the management server 23 stores the received posted label data and the like in the posted label database 25 (T15). The processing of T15 is an example of storage processing.

Specifically, the management server 23 creates a new label ID and stores it in the posted label database 25 as a new label ID 401 of the posted label related information 40. Thereafter, in the table of the posted label related information 40 corresponding to the new label ID 401, the received user ID of the poster is stored as the user ID (creator) 402, the received paid content list is stored as the paid content information 403, the received posted label data is stored as the posted label data 404, the print size information on the printing sheet suitable for printing the received posted label is stored as the label size information 405, and the year, month, and the date of the post date is stored as the post year, month, and date 406.

Next, the management server 23 transmits “registration complete” to the front server 22 (T16). Then, upon receiving “registration complete”, the front server 22 transmits “registration complete” to the terminal (poster) 12A of the poster (T17). Then, upon receiving “registration complete”, the terminal (poster) 12A displays that the registration of the posted label is complete on the display unit of the terminal (poster) 12A, and notifies the poster (T18). Accordingly, the poster can know that the posted label data has been registered in the label data sharing system.

### (Download Processing of Label Data)

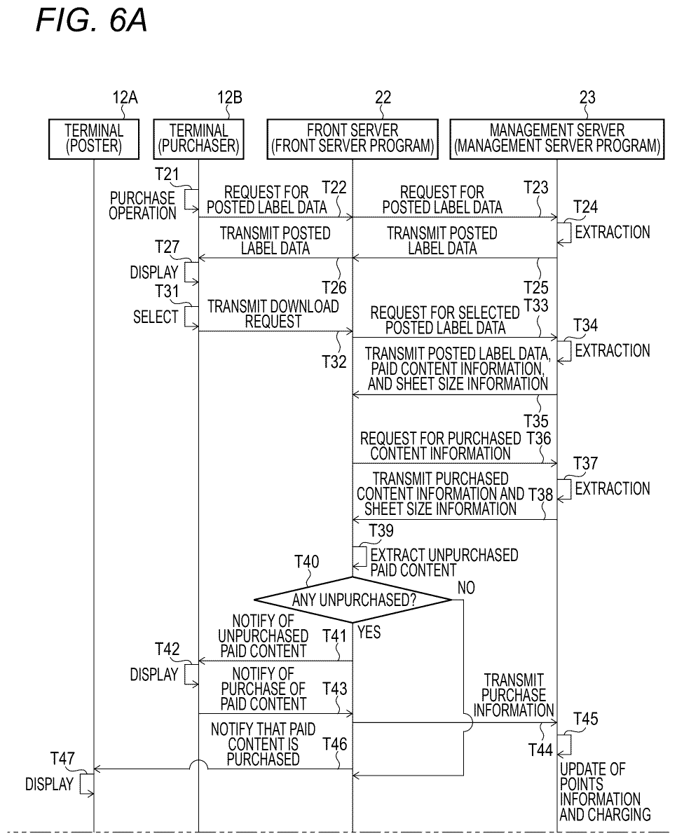

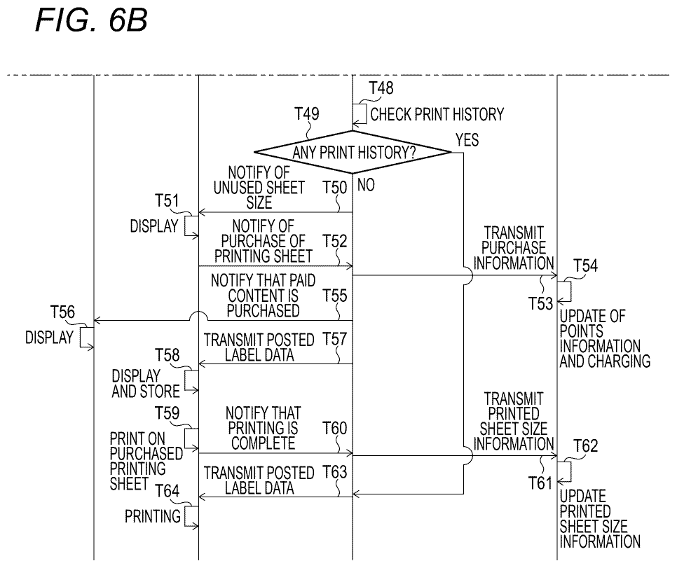

Next, an example of a procedure of download processing of the posted label data in the label data sharing service processing provided to the user by the front server program 227 of the front server 22 including operations of the client application 13 of the terminal 12 and the management server program 228 of the management server 23 will be described with reference to the sequence diagram of FIGS. 6A and 6B.

In the download processing of the posted label data according to the present embodiment, first, when a user who intends to execute download of the posted label data (hereinafter, referred to as a purchaser) activates the client application 13B of the terminal (purchaser) 12B and then touches a “label download” button (not illustrated) displayed on the terminal (purchaser) 12B (T21), the terminal (purchaser) 12B transmits a request for the posted label data to the front server 22 together with the user ID of the purchaser (T22). For example, the front server program 227 provides a login web page, the web page is displayed by the browser function of the client application 13B, and the user ID is input via the web page, thereby transmitting the user ID. When the login is approved, the front server 22 requests the management server 23 for the posted label data upon receiving the request for the posted label data (T23).

Next, upon receiving the request for the posted label data, the management server 23 extracts the posted label data stored as the posted label data 404 from the posted label database 25 together with the label ID stored as the label ID 401 (T24). At this time, if a plurality of pieces of posted label data are stored as the posted label data 404, the management server 23 extracts the plurality of pieces of posted label data and label IDs. The posted label data extracted at this time may be thumbnail image data of a label. Thereafter, the management server 23 transmits the extracted posted label data and label ID to the front server 22 (T25).

Next, upon receiving the posted label data and the label ID, the front server 22 transmits the received posted label data and label ID to the terminal (purchaser) 12B (T26). Then, upon receiving the posted label data and the label ID, the terminal (purchaser) 12B displays the received posted label data on the display unit of the terminal (purchaser) 12B (T27). For example, the front server program 227 provides a web page for selecting the posted label data, the web page is displayed by the browser function of the client application 13B, and the posted label data is displayed as a list via the web page.

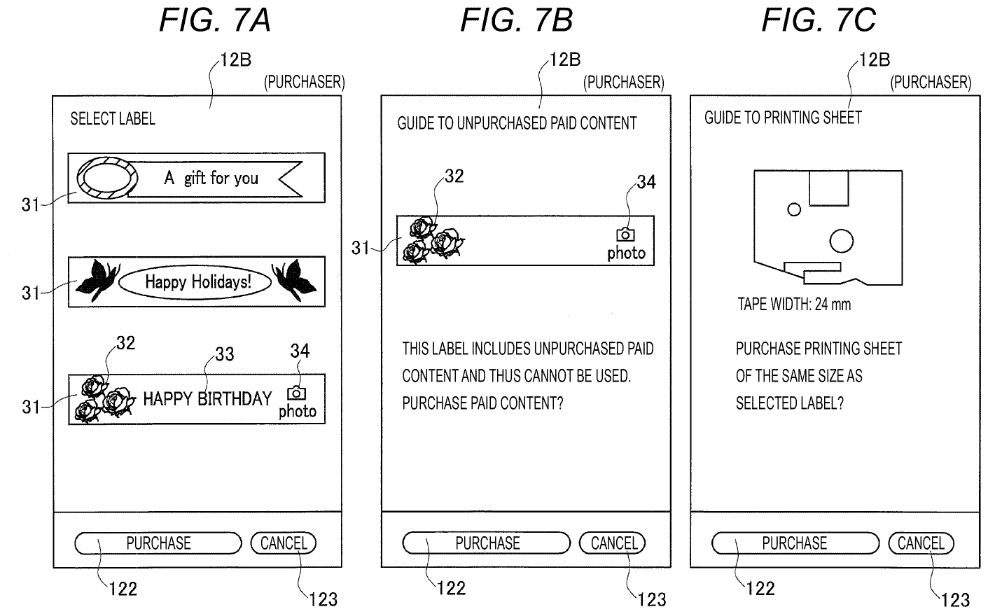

Specifically, in the present embodiment, as illustrated in FIG. 7A, three pieces of posted label data 31 are displayed on the display unit of the terminal (purchaser) 12B. If there are multiple pieces of the posted label data 31, the posted label data 31 may be displayed sequentially by the purchaser scrolling, or the posted label data 31 may be displayed sequentially by switching the display page.

Next, when the purchaser touches a “purchase” button 122 after selecting one of the posted label data displayed on the terminal (purchaser) 12B (T31), the terminal (purchaser) 12B transmits a download request together with the user ID of the purchaser and the label ID of the selected posted label data to the front server 22 to request the front server 22 to download the selected posted label data (T32). Then, upon receiving the download request for the selected posted label data, the front server 22 requests the management server 23 to download the selected posted label data (T33). The processing of T33 is an example of download acceptance processing.

Next, upon receiving the download request for the selected posted label data, the management server 23 extracts the posted label data stored as the posted label data 404 from the posted label database 25, the user ID (creator) from the user ID (creator) 402 stored in the label ID 401, the list of paid contents from the paid content information 403, and the sheet size information on the printing sheet from the label size information 405 for the selected posted label data, based on the received label ID (T34). Then, the management server 23 transmits the extracted posted label data, user ID (creator), paid content list, and sheet size information to the front server 22 (T35).

Next, upon receiving the posted label data and the like, the front server 22 requests the management server 23 for the purchased content information and the like on the purchaser (T36). Then, upon receiving the request for the purchased content information on the purchaser, the management server 23 extracts the requested purchased content information from the purchased content information 305 of the user database 24, based on the user ID of the purchaser. Further, based on the user ID of the purchaser, the sheet size information on the printed printing sheet is extracted from the printed sheet size information 306 of the user database 24 (T37). Then, the extracted purchased content information and sheet size information on the printed printing sheet is transmitted to the front server 22 by the management server 23, and thus is received by the front server 22 (T38). The processing of T38 is an example of acquisition processing and usage information acquisition processing. The size information on the printed printing sheet is an example of usage information.

Next, upon receiving the purchased content information and the sheet size information on the printed printing sheet, the front server 22 extracts paid content that is unpurchased by the purchaser of the posted label data, based on the list of paid contents received from the management server 23 in the processing of T35 and the list of purchased content information received from the management server 23 in the processing of T38 (T39), and then determines whether any paid content is unpurchased (T40). The processing of T40 is an example of determination processing.

when the front server 22 determines that no paid content is unpurchased in the processing of T40 (T40: NO), the front server 22 proceeds to the processing of T48 described later. When it is determined in the processing of T40 that some paid content is unpurchased (T40: YES), the front server 22 notifies the terminal (purchaser) 12B that some paid content is unpurchased (T41). The processing of T41 is an example of proposal processing.

Upon receiving the notification that some paid content is unpurchased, the terminal (purchaser) 12B displays that some paid content is unpurchased on the display unit of the terminal (purchaser) 12B, based on the notification (T42). Specifically, in the present embodiment, as illustrated in FIG. 7B, for example, a proposal screen including the posted label data 31 displaying the unpurchased paid contents 32 and 34 and a message is displayed on the display unit of the terminal (purchaser) 12B. For example, the front server program 227 provides a web page for the proposal screen, the web page is displayed by the browser function of the client application 13B, and the proposal screen is displayed via the web page. At this time, the “purchase” button 122 may be displayed on the display unit of the terminal (purchaser) 12B.

As described above, in the present embodiment, if the posted label data to be purchased includes paid content that is unpurchased by the purchaser, the purchase of the unpurchased paid content is proposed to the purchaser, thereby prompting the purchase of the paid content necessary for printing the posted label data, and facilitating the usage of the posted label data. In addition, proposal of the purchase enables immediate purchase of the unpurchased content, and particularly improves the convenience of the purchaser if the “purchase” button 122 is displayed on the display unit of the terminal (purchaser) 12B.

Next, when the purchaser views the display on the terminal (purchaser) 12B and touches the “purchase” button 122 displayed on the display unit of the terminal (purchaser) 12B, the terminal (purchaser) 12B notifies the front server 22 of the purchase of the paid content together with the label ID of the posted label data including the purchased paid content (T43). When the purchaser touches a “cancel” button 123 displayed on the terminal (purchaser) 12B, a message “Please select another label.” or the like is displayed on the display unit of the terminal (purchaser) 12B and the front server 22 is notified that the paid content is unpurchased, and then the terminal (purchaser) 12B ends this processing. Upon receiving that the paid content is unpurchased, the front server 22 ends the processing without executing the processing of T57 described later, that is, without transmitting the posted label data to the terminal (purchaser) 12B.

As described above, in the present embodiment, if unpurchased paid content is included in the posted label data, since the posted label data cannot be printed in a complete form even if printed using the printer 11, unnecessary processing such as download and printing of the posted label data can be omitted, thereby improving the usability of the label data sharing system.

Next, upon receiving the notification of the purchase of the unpurchased paid content, the front server 22 transmits purchase information on the unpurchased paid content to the management server 23 together with the user ID (creator) (T44).

Next, upon receiving the purchase information, the management server 23 updates the held points stored in the points information 303 of the user database 24 based on the user ID (creator), and executes charging to the purchaser (T45). That is, the management server 23 adds the held points stored in the points information 303 of the poster who posted the posted label currently purchased by the purchaser based on the user ID (creator). The processing of T45 is an example of addition processing.

Upon receiving the purchase of the unpurchased paid content, the front server 22 notifies the terminal (poster) 12A of the poster that the paid content is purchased and the held points are added (T46). Upon receiving the notification that the paid content is purchased, the terminal (poster) 12A displays the notification on the display unit of the terminal (poster) 12A (T47), and the poster can know that the paid content is purchased and the held points are added. The processing of T46 is an example of notification processing.

As described above, in the present embodiment, by notifying that the held points are updated, the poster can immediately understand that the held points are added, and an increase in the motivation of the poster to post the next label can be expected. The notification of the update of the held points may be configured such that, for example, a notification recipient corresponding to the user ID is registered in advance and a notification is pushed to the notification recipient.

Next, based on the sheet size information on the print sheet received in the processing of T35 and the printed sheet size information received in the processing of T38, the front server 22 checks whether the sheet size of the posted label has a history printed by the purchaser (T48). Thereafter, the front server 22 determines whether the sheet size has a print history by the purchaser (T49). Then, if determining that there is a print history by the purchaser (T49: YES), the front server 22 proceeds to the processing of T63 described later. If determining that there is no print history by the purchaser (T49: NO), the front server program 227 notifies the terminal (purchaser) 12B that the sheet size is unused (T50). The processing of T49 is an example of tape determination processing. The processing of T50 is an example of tape guidance processing.

Upon receiving the notification that the sheet size is unused, the terminal (purchaser) 12B displays a tape proposal screen for proposing that the sheet size is unused on the display unit of the terminal (purchaser) 12B based on the notification (T51). At this time, the “purchase” button 122 may be displayed. Specifically, in the present embodiment, the terminal (purchaser) 12B displays, for example, a tape proposal screen and the “purchase” button 122 as illustrated in FIG. 7C on the display unit, and proposes the purchaser of the posted label data to purchase the printing sheet (tape).

As described above, in the present embodiment, a printing sheet (tape) of a specific sheet size may not be purchased if the printing sheet of the specific sheet size set in the posted label data selected as the download target is not used, that is, does not have a print history. Therefore, by proposing the purchase of the printing sheet (tape) of the specific sheet size, it is possible to avoid a situation that the downloaded posted label data cannot be printed.

Next, when the purchaser views the display on the terminal (purchaser) 12B and touches the “purchase” button 122 displayed on the display unit of the terminal (purchaser) 12B, the terminal (purchaser) 12B notifies the front server 22 of the purchase of the printing sheet (tape) of the specific sheet size (T52).

As described above, in the present embodiment, if the “purchase” button 122 is displayed on the display unit of the terminal (purchaser) 12B, a printing sheet (tape) of a specific sheet size having no print history can be purchased immediately, thereby improving the convenience of the purchaser.

Further, when the purchaser touches the “cancel” button 123 displayed on the terminal (purchaser) 12B, the processing proceeds to the processing of T63 to be described later, thereby executing the download of the posted label data.

As described above, in the present embodiment, the download of the posted label data is executed even if the printing sheet (tape) of the specific sheet size is not used, and thus, printing can be immediately performed when the purchaser purchases the printing sheet later, thereby improving the convenience.

Next, upon receiving the purchase of the printing sheet, the front server 22 transmits purchase information to the management server 23 (T53).

Then, upon receiving the purchase information, the management server 23 updates the points information 303 of the user database 24. That is, the management server 23 adds the held points stored in the points information 303 of the poster who posted the posted label currently purchased by the purchaser based on the user ID (creator). Further, the management server program 238 executes the charging to the purchaser and prepares the printing sheet of the specific sheet size (T54).

Upon receiving the purchase of the printing sheet, the front server 22 notifies the terminal (poster) 12A of the poster that the printing sheet is purchased (T55). Upon receiving the notification that the sheet is purchased, the terminal (poster) 12A of the poster displays the notification on the display unit (T56), and the poster can know that the printing sheet is purchased and that the held points are added.

As described above, in the present embodiment, by notifying that the held points are updated, the poster can immediately understand that the held points are added, and an increase in the motivation of the poster to post the next label can be expected.

Further, upon receiving the purchase of the printing sheet, the front server 22 transmits the posted label data received in the processing of T35 to the terminal (purchaser) 12B of the purchaser (T57). Then, upon receiving the posted label data and the like, the terminal (purchaser) 12B of the purchaser displays on the display unit of the terminal (purchaser) 12B based on the received posted label data and the like, and stores the posted label data and the like in the storage unit (not illustrated) (T58). Afterwards, the purchaser executes printing based on the received posted label data and the like using the purchased (delivered) printing sheet (T59). The processing of T57 is an example of transmission processing.

Next, when the printing is complete in the terminal (purchaser) 12B of the purchaser, the front server 22 is notified of the completion of the printing (T60). Then, upon receiving the completion of the printing, the front server 22 transmits the printed sheet size information to the management server 23 (T61). Then, upon receiving the printed sheet size information, the management server 23 updates the printed sheet size information 306 of the user database 24 (T62). That is, in the user database 24, the printed sheet size information 306 of the purchaser is updated based on the user ID of the purchaser.

As described above, in the present embodiment, by managing the print history of the printing sheet by the system, the print history (usage information) for each purchaser can be managed even if a purchaser has a plurality of terminals 12, thereby improving the convenience.

Next, when the front server 22 determines that there is a print history by the purchaser in the previous processing of T49 (T49: YES), when the purchaser touches a “do not purchase” button in the processing of T51 (not illustrated) displayed on the terminal (purchaser) 12B, the front server 22 transmits the posted label data and the like received in the processing of T35 to the terminal 12B of the purchaser (T63). Then, upon receiving the posted label data and the like, the terminal (purchaser) 12B of the purchaser executes printing using the printer 11B based on the received posted label data and the like (T64). The processing of T63 is an example of a transmission method.

As described above, in the present embodiment, if the paid content included in the posted label data selected as the download target is unpurchased, the purchase of the unpurchased paid content is proposed, so that the purchaser who receives the proposal can easily notice that the paid content is unpurchased and can easily purchase the unpurchased paid content, thereby improving the convenience of the purchaser. In addition, the posted label data of the unpurchased paid content can be used after being purchased, thereby prompting sales of the paid content.

### Second Embodiment

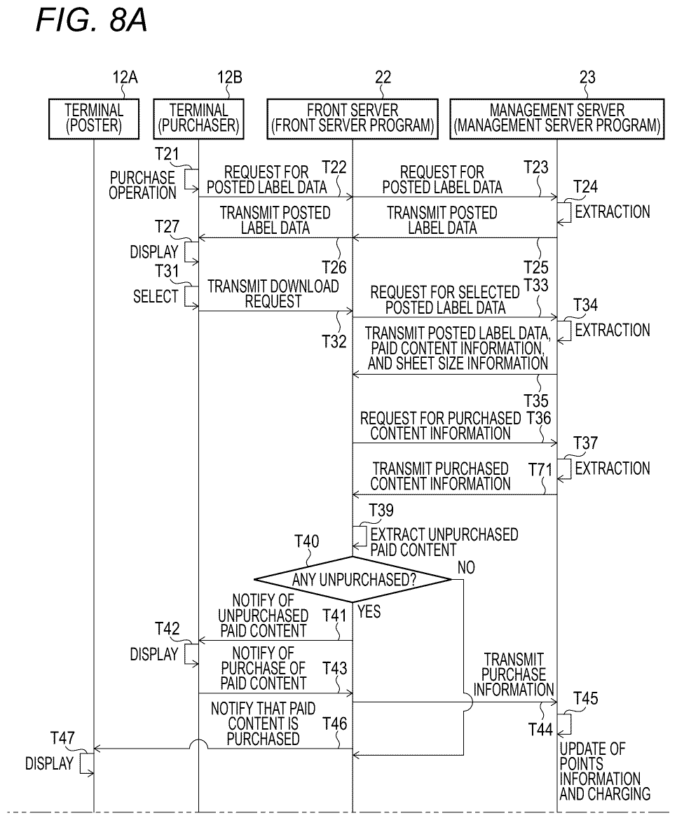

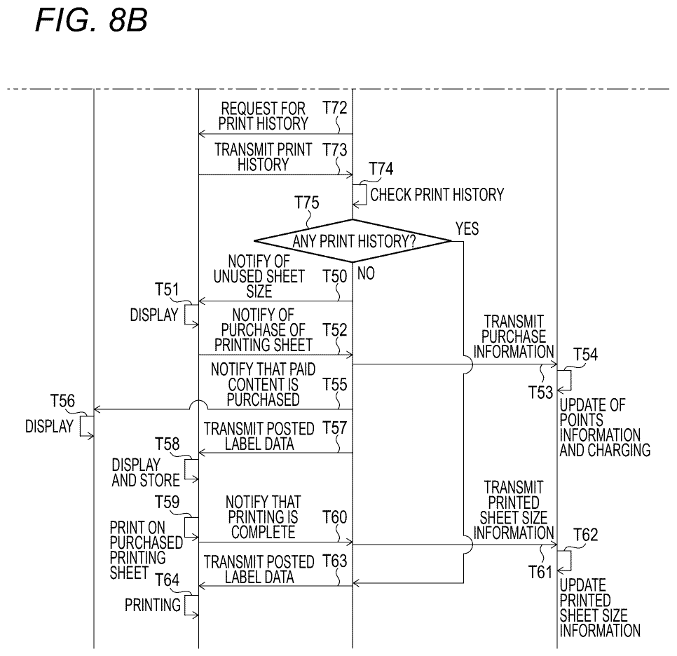

Next, an example of a procedure of label download in the label data sharing service processing provided to the user by the front server program 227 of the front server 22 including operations of the client application 13 of the terminal 12 and the management server program 228 of the management server 23 according to a second embodiment will be described with reference to the sequence diagram of FIGS. 8A and 8B. In the description, the same processing as those in the first embodiment is denoted by the same reference signs.

That is, in the first embodiment, since the management server 23 transmits the printed sheet size information to the front server 22 in the processing of T38, the front server program 227 is configured to receive the printed sheet size information from the management server 23, which is different in the second embodiment that the front server program 227 is configured to receive the print history stored in the terminal (purchaser) 12B from the terminal (purchaser) 12B.

In FIGS. 8A and 8B, since the management server 23 transmits the extracted purchased content information to the front server 22 (T71), the front server 22 receives the purchased content information transmitted by the management server 23. Then, the front server 22 sequentially executes the processing starting from T39 as in the first embodiment.

Next, the front server 22 transmits a print history request to the terminal (purchaser) 12B (T72). Then, upon receiving the request for the print history, the terminal (purchaser) 12B extracts the print history from the various types of information stored in the storage unit and transmits the print history to the front server 22 (T73).

Next, based on the label size information received in the processing of T35 and the print history received in the processing of T73, upon receiving the print history, the front server 22 checks whether the sheet size of the posted label has a history printed by the purchaser (T74). Thereafter, the front server 22 determines whether there is a print history by the purchaser (T75). Then, when determining that there is a print history by the purchaser (T75: YES), the front server 22 proceeds to the processing of T63 described later. When determining that there is no print history by the purchaser (T75: NO), the front server 22 proceeds to T50. Then, the front server 22 sequentially executes the processing starting from T50 as in the first embodiment.

As described above, in the present embodiment, the print history of the printing sheet is managed by the terminal (purchaser) that executed the printing, so that the print history can be appropriately managed even if different purchasers execute the printing using one terminal, thereby improving the convenience.

As described above in detail, if the paid content included in the posted label data selected as the download target is unpurchased, the purchase of the unpurchased paid content is proposed, so that the purchaser who receives the proposal can easily notice that the paid content is unpurchased and can easily purchase the unpurchased paid content, thereby improving the convenience of the purchaser. In addition, the held points of the poster are added when paid content or printing sheet is purchased, and thus an increase in the motivation of the poster to post the next label can be expected.

The embodiments disclosed in the present specification are merely an example, and does not limit the present invention. Therefore, various improvements and modifications can be naturally made to the technique disclosed in the present specification without departing from the gist of the present invention. The number of printers connected to the terminal is not limited to the illustrated example, and may be two or more.

In the present embodiment, the user database 24 and the posted label database 25 are connected to one management server 23, but the user database 24 and the posted label database 25 may be connected to separate management servers.

In any sequence diagram disclosed in the embodiments, an execution order of any plurality of processes can be freely changed or can be executed in parallel within a range in which no contradiction occurs in a processing content.

The processes disclosed in the embodiments may be executed by hardware such as a single CPU, a plurality of CPUs, and an ASIC, or a combination thereof. In addition, the processes disclosed in the embodiments can be implemented in various modes such as a recording medium in which a program for executing the processes is recorded, or a method.

What is claimed is:

1. A non-transitory computer readable storage medium storing a program configured to be executed by a server,
the server being configured to store label data,
the label data being configured to be printed by a label printer,
the label data being configured to include a setting of a paid content or paid function,
the server being configured to access a purchase information database,
the purchase information database storing purchase information indicating whether a paid content and function have been purchased for each user ID,
the program comprising instructions which, when executed by the server, cause a computer of the server to execute:
download acceptance processing of accepting a user ID, selection of the label data to be downloaded, and a download instruction, from an information processing device;
in a case where the download instruction from the information processing device is accepted in the download acceptance processing:
transmission processing of transmitting the label data selected in the download acceptance processing to the information processing device;
acquisition processing of accessing the purchase information database to acquire the purchase information corresponding to the user ID accepted in the download acceptance processing; and
determination processing of determining whether the label data selected in the download acceptance processing includes a setting of an unpurchased content or function, based on the purchase information acquired in the acquisition processing, and
in a case where it is determined in the determination that the setting of unpurchased content or function is included:
proposal processing of proposing purchase of the unpurchased content or function included in the label data selected in the download acceptance processing.

2. The non-transitory computer readable storage medium according to claim 1,
wherein, in the proposal processing, the computer is configured to accept a purchase instruction for the unpurchased content or function included in the label data selected in the download acceptance processing, and
in a case where the purchase instruction is accepted, the instructions cause the computer to execute purchase processing of purchasing the unpurchased content or function.

3. The non-transitory computer readable storage medium according to claim 1,
wherein the label data is configured to include a setting of a type of a tape, and
in a case where the computer accepts the download instruction from the information processing device in the download acceptance processing, the instructions further cause the computer of the server to execute:
usage information acquisition processing of acquiring usage information indicating whether each type of tape is used, the usage information corresponding to the user ID accepted in the download acceptance processing;
tape determination processing of determining whether a specific tape set as the type of the tape included in the label data selected in the download acceptance processing is used, based on the usage information acquired in the usage information acquisition processing; and
in a case where it is determined in the tape determination processing that the specific tape is not used, tape proposal processing of proposing purchase of the specific tape.

4. The non-transitory computer readable storage medium according to claim 3,
wherein the server is configured to access a usage information database, the usage information database storing the usage information for each user ID,
in a case where printing is performed in a label printer based on an instruction from the information processing device, the usage information is updated in the usage information database for the tape used in the printing, and
in the usage information acquisition processing, the computer is configured to access the usage information database to read and acquire the usage information corresponding to the user ID accepted in the download acceptance processing.

5. The non-transitory computer readable storage medium according to claim 3,
wherein the information processing device is configured to store the usage information,
in a case where the information processing device causes the label printer to perform the printing, the information processing device is configured to update the usage information for the tape used in the printing, and
in the usage information acquisition processing, the computer is configured to receive the usage information from the information processing device to acquire the usage information corresponding to the user ID accepted in the download acceptance processing.

6. The non-transitory computer readable storage medium according to claim 1,
wherein the instructions further cause the computer of the server to:
in a case where it is determined in the determination processing that the setting of unpurchased content or function is not included, execute the transmission processing; and
in a case where it is determined in the determination processing that the setting of unpurchased content or function is included, execute the proposal processing without executing the transmission processing.

7. The non-transitory computer readable storage medium according to claim 1,
wherein the instructions further cause the computer of the server to execute:
upload acceptance processing of accepting upload instruction of the label data from the first information processing device,
in a case where the upload instruction of the label data is accepted in the upload acceptance processing:
reception processing of receiving posted label data that is the label data uploaded, from the first information processing device; and
storage processing of storing the posted label data received in the reception processing, and
the instructions further cause the computer of the server to:
in a case where the user ID, the selection of the posted label data as a download target and the download instruction are accepted from a second information processing device in the download acceptance processing:
in the transmission processing, transmit the posted label data selected in the download acceptance processing to the second information processing device;
in the determination processing, determine whether the posted label data selected in the download acceptance processing includes a setting of unpurchased content or function, based on the purchase information acquired in the acquisition processing; and
in the proposal processing, in a case where it is determined in the determination processing that the posted label data includes a setting of unpurchased content or function, propose purchase of the unpurchased content or function included in the posted label data selected in the download acceptance processing.

8. The non-transitory computer readable storage medium according to claim 7,
wherein the server is configured to access a points database storing held points for each user ID, the held points being points held by a user,
in the upload acceptance processing, the computer is configured to accept a user ID and the upload instruction from the first information processing device,
in the storage processing, the computer is configured to store the posted label data received in the reception processing in association with the user ID accepted in the upload acceptance processing,
in the proposal processing:
the computer is configured to receive a purchase instruction for the unpurchased content or function included in the label data selected in the download acceptance processing,
in a case where the purchase instruction is accepted, the instructions cause the computer to execute purchase processing of purchasing the unpurchased content or function, and
in a case where the posted label data is selected in the download acceptance processing and the unpurchased content or function is purchased in the purchase processing, the instructions further causes the computer of the server to execute addition processing of accessing the points database to add the held points corresponding to the user ID associated with the posted label data selected in the download acceptance processing.

9. The non-transitory computer readable storage medium according to claim 8,
wherein in a case where the held points are added in the addition processing, the instructions cause the computer of the server to execute notification processing of notifying the first information processing device of an update of the held points, the first information processing device uploading the posted label data selected in the download acceptance processing.

10. A server for connecting to an information processing device via a network,
wherein the server is configured to store label data configured to include a setting of a paid content or paid function,
the server is configured to access a purchase information database storing purchase information indicating whether a paid content and function have been purchased for each user ID,
the server is configured to execute:
download acceptance processing of accepting a user ID, selection of the label data to be downloaded, and a download instruction, from an information processing device;
in a case where the download instruction from the information processing device is accepted in the download acceptance processing:
transmission processing of transmitting the label data selected in the download acceptance processing to the information processing device;
acquisition processing of accessing the purchase information database to acquire the purchase information corresponding to the user ID accepted in the download acceptance processing; and
determination processing of determining whether the label data selected in the download acceptance processing includes a setting of an unpurchased content or function, based on the purchase information acquired in the acquisition processing, and
in a case where it is determined in the determination processing that the setting of unpurchased content or function is included:
proposal processing of proposing purchase of the unpurchased content or function included in the label data selected in the download acceptance processing.

11. A label data sharing system comprising:
a first information processing device;
a second information processing device; and
a server,
wherein the first information processing device and the second information processing device are configured to connect to the server via a network,
the server is configured to store label data in association with a user ID, the label data being data configured to be printed by a label printer, the label data being configured to include a setting of a paid content or paid function,
the first information processing device is configured to upload posted label data to the server in association with the user ID input to the first information processing device, the posted label data being label data that the first information processing device has,
the server is configured to store the posted label data uploaded from the first information processing device in association with the user ID associated with the uploaded posted label data,
the second information processing device is configured to download the posted label data stored in the server from the server,
the server is further configured to:
access a purchase information database storing purchase information indicating whether a paid content and function have been purchased for each user ID; and
accept a user ID and a download instruction form the second information processing device;
in a case where the server accepts the download instruction of the posted label data from the second information processing device, the server executes:
transmission processing of transmitting the posted label data to the second information processing device;
acquisition processing of accessing the purchase information database and acquiring the purchase information corresponding to the user ID accepted from the second information processing device; and
determination processing of determining whether the posted label data to download includes a setting of an unpurchased content or function, based on the purchase information acquired in the acquisition processing, and
in a case where it is determined in the determination processing that the setting of unpurchased content or function is included, the server further executes:
proposal processing of proposing purchase of the unpurchased content or function included in the posted label data to download.
